(19) United States
(12) Patent Application Publication
(10) Pub. No.: US 2011/0036728 A1
(43) Pub. Date: Feb. 17, 2011

(54) LOW-ENERGY ELECTROCHEMICAL PROTON TRANSFER SYSTEM AND METHOD

(75) Inventor: Kasra FARSAD, San Jose, CA (US)

Correspondence Address: Calera Corporation;Eric Witt, 14600 Winchester Blvd., Los Gatos, CA, 95032, US

(73) Assignee: Calera Corporation

(21) Appl. No.: 12/989,785

(22) PCT Filed: Dec. 23, 2008
(86) PCT No.: PCT/US08/88246

§ 371 Date: Oct. 26, 2010

(51) Int. Cl. C25B 1/00; C25B 9/18; C25B 9/00; C02F 1/461

(52) U.S. Cl. 205/770; 204/253; 204/258; 204/257

(57) ABSTRACT

A low energy method and system of removing H⁺ from a solution in an electrochemical cell wherein on applying a voltage across an anode in a first electrolyte and a cathode in second electrolyte, H⁺ are transferred to second electrolyte through a proton transfer member without forming a gas, e.g., oxygen or chlorine at the electrodes.

### BACKGROUND

In many chemical processes a solution from which protons (H⁺) are removed is required to achieve or modulate a chemical reaction. One way to remove H⁺ from a solution is to dissolve an alkali hydroxide such as sodium hydroxide or magnesium hydroxide in the solution. However, conventional processes for producing alkali hydroxides are very energy intensive, e.g., the chlor-alkali process, and they emit significant amounts of carbon dioxide and other greenhouse gases into the environment.

### SUMMARY

In various embodiments, the present invention relates to a low energy method and system for removing H⁺ from a solution utilizing a conductive proton transfer member in an electrochemical cell without generating gas at the electrodes. In one embodiment, H⁺ are transferred from a first electrolyte to a second electrolyte through the proton transfer member by biasing a voltage on an anode in contact with the first electrolyte positive relative to the proton transfer member; and biasing a cathode in contact with the second electrolyte negative relative to the proton transfer member. In the system, the proton transfer member is in contact with both electrolytes and isolates the first electrolyte from the second electrolyte. By the present invention, on applying a low voltage across the electrodes, H⁺ are transferred from the first electrolyte to the second electrolyte through the proton transfer member without forming a gas, e.g., oxygen or chlorine at the electrodes.

In one embodiment, the method comprises biasing a voltage on a first electrode positive relative to a conductive proton transfer member, and a voltage on a second electrode negative relative to the proton transfer member to establish a current through the electrodes in an electrochemical system wherein the proton transfer member isolates the first electrolyte from a second electrolyte, the first electrolyte contacting the first electrode and the second electrolyte contacting the second electrode. By the present method, on applying a low voltage across the electrodes, H⁺ are transferred from the first electrolyte to the second electrolyte through the proton transfer member without forming a gas, e.g., oxygen or chlorine at the electrodes.

In an another embodiment, the method comprises utilizing a proton transfer member to isolate a first electrolyte from a second electrolyte; biasing a voltage on an anode in contact with the first electrolyte positive relative to the proton transfer member; and biasing a voltage on the cathode contacting the second electrolyte negative relative to the proton transfer member. On applying a low voltage across the electrodes, H⁺ are transferred from the first electrolyte to the second electrolyte through the proton transfer member without generating a gas, e.g., chlorine or oxygen at the electrodes.

In another embodiment, the system comprises an anode in contact with a first electrolyte; a cathode in contact with a second electrolyte; a conductive proton transfer member isolating the first electrolyte from the second electrolyte; and a voltage regulator operable to bias a voltage on the anode positive relative to the proton transfer member, and to bias a voltage on the cathode negative relative to the proton transfer member. In the system, on applying a low voltage across the electrodes, H⁺ are transferred from the first solution to the second solution through the proton transfer member without forming a gas, e.g., chlorine or oxygen at the electrodes on applying a low voltage across the electrodes.

In another embodiment, the system comprises a first electrolytic cell comprising an anode in contact with a first electrolyte; a second electrolytic cell comprising a cathode in contact with a second electrolyte; a conductive proton transfer member positioned to isolate the first electrolyte from the second electrolyte; a first conduit positioned to supply positive ions to the first electrolyte; a second conduit positioned to supply negative ions into the second electrolyte; and a voltage regulator operable to establish a current through the electrodes by biasing a voltage on the first electrode positive relative to the proton transfer member, and biasing a voltage on the second electrode negative relative to the proton transfer member. In the system, H⁺ are transferred from the first solution to the second solution through the proton transfer member without forming a gas, e.g., chlorine or oxygen at the electrodes on applying a low voltage across the electrodes.

By the present invention, the H⁺ concentration in the first electrolyte contacting the anode may decrease, remain constant, or increase depending on the flow of first electrolyte around the anode. Similarly, the H⁺ concentration in the second electrolyte contacting the cathode may increase, decrease, or increase depending on the flow of second electrolyte around the cathode.

In one embodiment, the solution from which H⁺ are removed may be used to sequester CO₂ by precipitating carbonates and bicarbonates from a solution containing dissolved salts of alkali metals. The precipitated carbonates in various embodiments may be used as building products, e.g., cement materials as described in U.S. Provisional Patent Application Ser. No. 60/931,657 filed on May 24, 2007; U.S. Provisional Patent Application Ser. No. 60/937,786 filed on Jun. 28, 2007; U.S. Provisional Patent Application 61/017,419, filed on Dec. 28, 2007; U.S. Provisional Patent Application Ser. No. 61/017,371, filed on Dec. 28, 2007; and U.S. Provisional Patent Application Ser. No. 61/081,299, filed on Jul. 16, 2008 herein incorporated by reference.

In another embodiment the solution depleted of alkali metal ions may be used as a desalinated water as described in the United States Patent Applications incorporated herein by reference. In one embodiment the solution containing precipitated carbonates may be disposed in an ocean at a depth at which the temperature and pressure are sufficient to keep the carbonates stable, as described in the United States Patent Applications incorporated herein by reference. Also, the second solution into which H⁺ are transferred may be acidified and used to dissolve alkali-metal minerals e.g., mafic minerals for use in sequestering CO₂ as described in the United States Patent Applications incorporated herein by reference.

### BRIEF DESCRIPTION OF THE DRAWINGS

The following drawings illustrate embodiments of the present system and method by way of examples and not limitations. The methods and systems may be better understood by reference to one or more of these drawings in combination with the description herein:

FIG. 1 is an illustration of an embodiment of the present system.

FIG. 2 is an illustration of an embodiment of the present system.

FIG. 3 is an illustration of an embodiment of the present system.

FIG. 4 is an illustration of an embodiment of the present system.

FIG. 5 is a flow chart of an embodiment of the present method.

FIG. 6 is a flow chart of an embodiment of the present method.

FIG. 7 is a flow chart of an embodiment of the present method.

### DETAILED DESCRIPTION

Before the present methods and systems are described in detail, it is to be understood that this invention is not limited to particular embodiments described and illustrated herein, as such may vary. It is also to be understood that the terminology used herein is for the purpose of describing particular embodiments only, and is not intended to be limiting, since the scope of the present invention will be limited only by the appended claims.

Where a range of values is provided, it is to be understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods, systems and materials similar or equivalent to those described herein can also be used in the practice or testing of the present invention, representative illustrative methods, systems and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

As used herein and in the appended claims, the singular forms “a,” “an,” and “the” include plural references unless the context clearly dictates otherwise. Also, the claims may be drafted to exclude any optional element. As such, this statement is intended to serve as antecedent basis for use of such exclusive terminology as “solely,” “only” and the like in connection with the recitation of claim elements, or use of a “negative” limitation. Additionally, the term “reservoir” as used herein refers to an enclosure for holding a liquid such as a vessel, tank, chamber or bag.

As will be apparent to those of skill in the art, each of the embodiments described and illustrated herein has discrete components and features which may be readily separated from or combined with the features of any of the other several embodiments without departing from the scope or spirit of the present invention. Any recited method can be carried out in the order of events recited or in any possible logical order.

The present invention relates to a system and method for transferring protons (H⁺) from one solution to another utilizing a proton transfer member in an electrochemical cell. By transferring H⁺ from one solution to the other through the proton transfer member, the concentration of H⁺ in the solutions are adjusted, i.e. the pH of one solution may decrease, i.e., the solution becomes more acidic, while the pH of the other solution may increase, i.e., the solution becomes more basic. Thus if one solution contains a proton source and/or a proton sink, the pH of the solutions may or may not change; or may change slowly; or may even change in the opposite direction from that predicted by proton removal or addition. In various embodiments, the basic solution may be used to sequester CO₂, and the acidic solution may be used to dissolve calcium and magnesium bearing minerals to provide a solution of calcium and magnesium ions for sequestering CO₂ as described in the United States Patent Applications incorporated herein by reference.

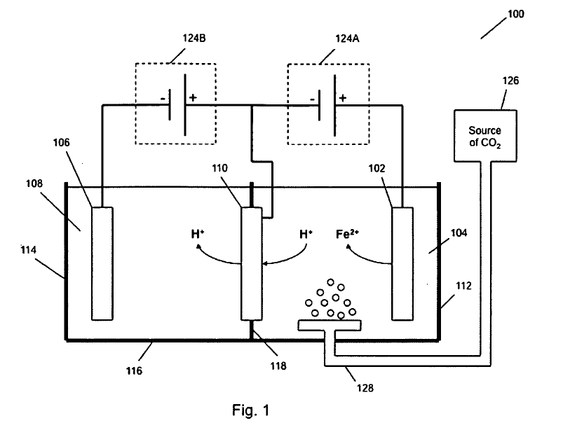

FIGS. 1 to 4 illustrate various embodiments of the present system; these embodiments are illustrative only and in no way limit the invention. Referring to FIG. 1, system 100 in one embodiment comprises a first electrode 102, e.g., an anode contacting a first electrolyte 104; a second electrode 106, e.g., a cathode contacting a second electrolyte 108; a proton transfer member 110 isolating first electrolyte 104 from second electrolyte 108; and voltage regulators 124A and 124B operable to bias a voltage on first electrode 102 positive relative to proton transfer member 110, and to bias a voltage on second electrode 106 negative relative to the proton transfer member. In various embodiments, the voltage regulator is set to a voltage such that a gas, e.g., oxygen or chlorine gas does not form at the electrodes.

In the embodiment illustrated in FIG. 1, first electrode 102 and first electrolyte 104 are contained in a first electrolytic or cell 112; and second electrode 106 and second electrolyte 108 are contained in a second electrolytic cell 114. The proton transfer member isolates the first electrolyte from the second electrolyte. As is illustrated in FIGS. 1-4, proton transfer member 110 member may constitute an entire barrier 118 between electrolytes 104, 108, or a portion thereof. In embodiments where proton transfer member 110 constitutes only a portion of barrier 118, the remainder of the barrier may comprise an insulating material.

In various embodiments, proton transfer material 110 comprises a noble metal, a transition metal, a platinum group metal, a metal of Groups IVB, VB, VIB, or VIII of the periodic table of elements, alloys of these metals, oxides of these metals, or combinations of any of the foregoing. Other exemplary materials include palladium, platinum, iridium, rhodium, ruthenium, titanium, zirconium, chromium, iron, cobalt, nickel, palladium-silver alloys, palladium-copper alloys or amorphous alloys comprising one or more of these metals. In various embodiments, the proton transfer member comprises a non-porous materials from the titanium and vanadium groups, or comprise complex hydrides of group one, two, and three light elements of the Periodic Table such as Li, Mg, B, and Al. In other embodiments, a non-conductive or poorly conductive material can be made conductive to function as a proton transfer member, e.g., by depositing a thin metal coating on a substrate. In various embodiments, the proton transfer material 110 comprises a supported film or foil. In some embodiments, the proton transfer material 110 comprises palladium.

In various embodiments the electrolyte solution in first and second electrolytic cell 112, 114 comprises a conductive aqueous electrolyte such as a solution of sodium chloride or another saltwater electrolyte including seawater, brine, or brackish fresh water. In either cell, the electrolytes may be obtained from a natural source, or artificially created, or a combination of a natural source that has been modified for operation in the present method and/or system.

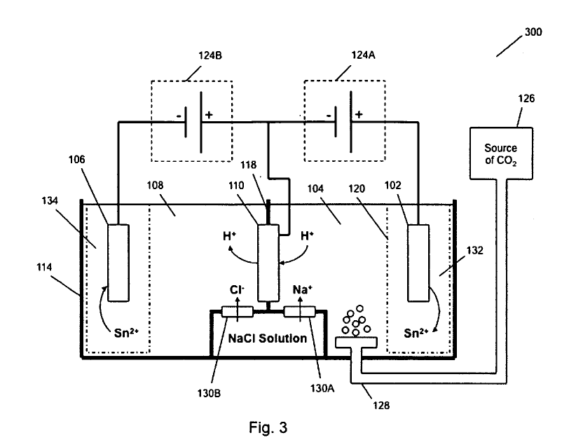

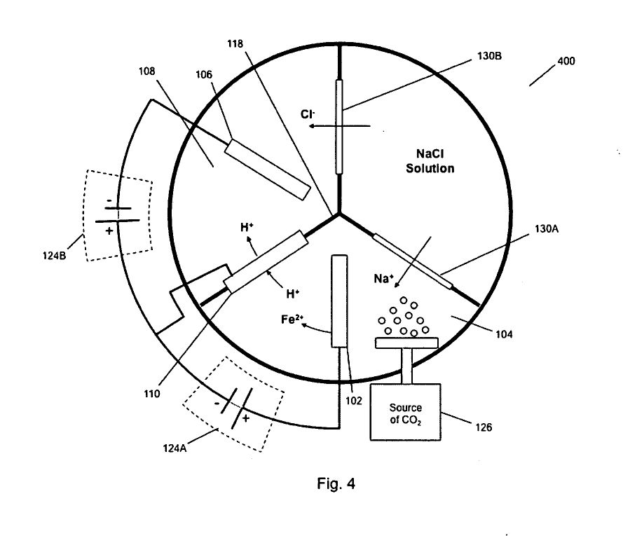

In an embodiment of the system as illustrated in FIGS. 3 and 4, first electrolytic solution 104 is augmented with cations ions, e.g., sodium ions, obtained, for example, by processing a sodium chloride solution through a cationic membrane 130A. Similarly, electrolytic solution 108 is augmented with anions ions, e.g., chloride ions obtained, for example, by processing a sodium chloride solution through a anionic membrane 130B. As is illustrated in FIG. 3 by biasing first 102 and second 106 electrodes as described herein, protons are removed from the first electrolyte. If protons in the first electrolyte are not replenished, or are replenished more slowly than they are removed, then the pH of the first electrolyte 104 from which protons are removed will increase and will form a basic solution, e.g. a sodium hydroxide solution. Similarly by introducing chloride ions in second electrolyte 108 and transferring proton into the second electrolyte, if protons in the second electrolyte are not removed, or are removed more slowly than they are added, then the pH of the second electrolyte 184 to which protons are transferred will decrease and will form an acidic solution, e.g. a hydrochloric acid solution.

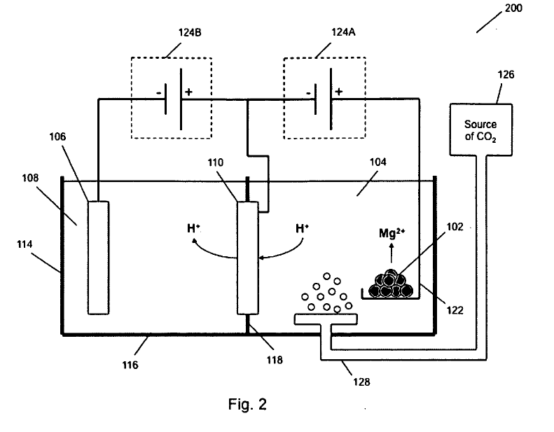

With reference to FIGS. 1-4, in various embodiments first electrode 102 comprises an anode, and second electrode 106 comprises a cathode. In various embodiments, the anode 102 may comprise a sacrificial anode, e.g., iron, tin, magnesium, calcium or combinations thereof and/or a mineral. Exemplary materials include a mineral, such as a mafic mineral e.g., olivine or serpentine that provide cations as illustrated in FIG. 2. Where the anode 102 comprises a mineral 102 and functions as a source of cations, e.g., Mg²⁺ as illustrated in FIG. 2, the mineral is positioned on a chemically inert carrier 122 such as stainless steel or platinum. Any suitable mineral may be used; selection of the mineral is based on the cation or cations desired for release, availability, cost and the like.

System 100, 200, 300, 400 also comprise a voltage regulator and/or power supply 124A, 124B configured to bias first electrode 102 positive relative to proton transfer member 110, and to bias second electrode 106 negative to proton transfer member 110. In various embodiments, the power supply comprises two separate power supplies 124A, 124B as illustrated in FIGS. 1-4, one configured to bias the first electrode positively relative to the proton transfer member, and another configured to bias the second electrode negative relative to the proton transfer member 110. The power supply can be configured in alternative ways as will be appreciated by one ordinarily skilled in the art.

In operation, power supply 124A, 124B drives an chemical reaction in which, without intending to be bound by any theory, it is believed that hydrogen ions in first electrolyte solution 104 are reduced to atomic hydrogen and adsorb on the surface of proton transfer member 110 in contact with first electrolyte 102. At least a portion of the adsorbed hydrogen is absorbed in the body of proton transfer member 110, and desorbs on the surface of proton transfer member 110 in second electrolyte 108 in contact with proton transfer member 110 as protons. Regardless of mechanism, the result of the chemical reaction is removal of proton from first electrolyte 104, and introduction of protons into second electrolyte 108. In embodiments wherein the electrode 102 comprises an oxidizable material, e.g., iron or tin the electrode 102 is oxidized to release iron ions (e.g., Fe²⁺ and/or Fe³⁺ or tin ions Sn²⁺) into first electrolyte solution 104 to balance the transfer of protons from electrolyte 104.

In the present system, voltages on electrodes 102, 106 are biased relative to proton transfer member 110 such that a gas does not form on the electrodes 102, 106. Hence, where first electrolyte 104 comprises water, oxygen does not form on first electrode 102. Similarly, wherein the first electrolyte comprises chloride ions, e.g., an electrolyte comprising salt water, chlorine gas does not form on the first electrode. As can be appreciated by one ordinarily skilled in the art, depending on the voltage applied across the system and the flow rate of electrolytes through the system, the pH of the solutions will be adjusted. In one embodiment, when a volt of about 0.1 V or less, 0.2 V or less, . . . 0.1 V or less is applied across the anode and cathode, the pH of the first electrolyte solution increased; in another embodiment, when a volt of about 0.1 to 2.0 V is applied across the anode and cathode the pH of the first electrolyte increased; in yet another embodiment, when a voltage of about 0.1 to 1 V is applied across the anode and cathode the pH of the first electrolyte solution increased. Similar results are achievable with voltages of 0.1 to 0.8 V; 0.1 to 0.7 V; 0.1 to 0.6 V; 0.1 to 0.5 V; 0.1 to 0.4 V; and 0.1 to 0.3 V across the electrodes. In one embodiment, a volt of about 0.6 volt or less is applied across the anode and cathode; in another embodiment, a volt of about 0.1 to 0.6 volt or less is applied across the anode and cathode; in yet another embodiment, a voltage of about 0.1 to 1 volt or less is applied across the anode and cathode. In one embodiment, a volt of about 0.6 volt or less is applied across the anode and cathode; in another embodiment, a volt of about 0.1 to 0.6 volt or less is applied across the anode and cathode; in yet another embodiment, a voltage of about 0.1 to 1 volt or less is applied across the anode and cathode.

In various embodiments as illustrated in FIGS. 1-4, system 100-400 optionally comprises a source of CO₂ 126 coupled to a gas injection system 128 disposed in first cell 112. The gas injection system mixes a gas including CO₂ supplied by the source of CO₂ into first electrolyte solution 104. Exemplary sources of CO₂ are described in the United States Patent Applications incorporated herein by reference, and can include flue gas from burning fossil fuel burning at power plants, or waste gas from an industrial process e.g., cement manufacture or steel manufacture, for example. In various embodiments, gas injection system 128 comprises a sparger or injection nozzle; however, any conventional mechanism and apparatus for introducing CO₂ into an aqueous solution may be used.

Referring to FIGS. 3-4, system 100 in an alternative embodiment comprises a conduit 130A positioned to supply a solution of positive ions e.g., sodium ions into first electrolyte 104, and conduit 130B positioned to supply negative ions, e.g., chloride ions into second electrolyte 108. In various embodiments, conduits 130A, 130B are adaptable for batch or continuous fluid flow. As illustrated in FIGS. 3-4, the system comprises a first electrolytic cell 112 comprising a first electrode 102 contacting a first electrolyte 104; a second electrolytic cell 114 comprising a second electrode 106 contacting a second electrolyte 108; a proton transfer member 110 positioned to isolate the first electrolyte from the second electrolyte; a first conduit 130A positioned to supply positive ions to the first electrolyte; a second conduit 130B positioned to supply negative ions into the second electrolyte; and voltage regulators 124A, 124B operable to establish a current through electrodes 102, 106 by biasing a voltage on first electrode 102 positive relative to the proton transfer member 110, and a voltage on the second electrode 106 negative relative to the proton transfer member.

In some embodiments, e.g., where CO₂ is introduced, proton are both removed and introduced into electrolyte solution 104, and the net result—net removal, no change, or net introduction of protons—will depend on the relative rates of protons removal and introduction of other species in the solution e.g., CO₂ introduction. Similarly, in electrolyte solution 108, if there is a process that removes protons, e.g., by dissolution of a basic substance, then the net result in electrolyte solution 108 may be introduction of, no change in, or removal of protons.

In some embodiments, there is a net removal of protons (coupled with introduction of cations) in electrolyte solution 104, and/or a net introduction of protons (couple with introduction of anions, e.g., chloride) in electrolyte solution 108. Thus, in some embodiments, a cationic hydroxide, e.g., sodium hydroxide will form in first electrolyte solution 104 and/or hydrogen anion solution, e.g., hydrochloric acid will form in second solution 108. Either or both of cationic hydroxide solution, e.g., sodium hydroxide, or the anionic hydrogen anionic solution, e.g., hydrochloric acid can be withdrawn and used elsewhere, e.g., in the sequestration of carbon dioxide as describe above, and in other industrial applications.

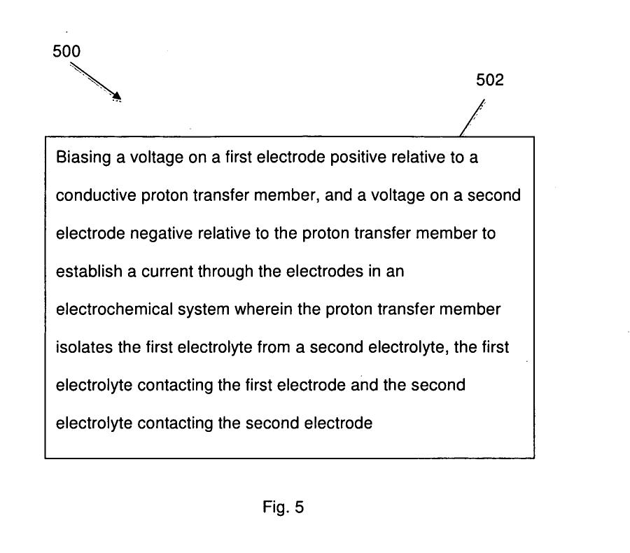

FIGS. 5 to 7 illustrate various embodiments of the present method of removing protons from an electrolyte. Referring to FIG. 5 and the systems of FIG. 1-4, in one embodiment the method 500 includes a step 502 of biasing a voltage on a first electrode positive relative to a conductive proton transfer member, and a voltage on a second electrode negative relative to the proton transfer member to establish a current through the electrodes in an electrochemical system wherein the proton transfer member isolates the first electrolyte from a second electrolyte, the first electrolyte contacting the first electrode and the second electrolyte contacting the second. In step 502, proton transfer member 110 is positioned in an electrochemical system 100 to separate the electrolyte 104 from the second electrolyte 108, as described with reference to FIGS. 1-4.

As described with reference to FIGS. 1-4, in step 502, hydrogen ions are removed from first electrolyte solution 104 and introduced into second electrolyte solution 108 through proton transfer member 110 in contact with the first and second electrolyte solutions. In various embodiments first electrode 102 is configured to function as an anode with respect to proton transfer member 110, and second electrode 106 is configured to function as a cathode with respect to proton transfer member 110.

In various embodiments, the step of biasing a voltage on a first electrode positive relative to a conductive proton transfer member, and a voltage on a second electrode negative relative to the proton transfer member to establish a current through the electrodes in an electrochemical system wherein the proton transfer member isolates the first electrolyte from a second electrolyte, the first electrolyte contacting the first electrode and the second electrolyte contacting the second electrode are performed simultaneously. In various embodiments the voltage biases between the first electrode and the proton transfer member, and the second electrode and the proton transfer member are approximately equal and are controlled to prevent the formation of a gas on the electrodes. In some embodiments, substantially no gas is formed in the system from electrochemical process, e.g., no hydrogen, oxygen or chlorine gas is formed at the electrodes. In particular, depending on the ions present in first electrolyte 104, the voltages are biased to prevent the formation of oxygen at first electrode 102; similarly, the voltages are biased to prevent the formation of chlorine gas at the first electrode. In some embodiments, the voltages are based such that substantially no gas is formed in the system, e.g., oxygen or chlorine does not form at the electrodes.

As described with reference to the operation of the systems of FIGS. 1-4, by biasing the voltage on first electrode 102 positively relative to proton transfer member 110, and biasing voltage on second electrode 106 negative relative to the proton transfer member, protons are removed from first electrolyte 104 and introduced into the second electrolyte on the opposite side of proton transfer member 110, without forming a gas on the first electrode. Also, as a result of biasing the voltages on the electrodes relative to the proton transfer member, hydrogen ions are introduced from the surface of the proton transfer member in contact with the second electrolyte into the second electrolyte. Consequently, in some embodiments, the H⁺ concentration may decreases in first electrolyte 104, resulting in an increase in the pH of the first electrolyte; and may increase in the second electrolyte resulting in a decrease in the pH of the second electrolyte.

As described above with reference to operation of the present system, in various embodiments, the first electrolyte and second electrolytes comprise an aqueous solution containing ions sufficient to establish a current in the system through electrodes 102, 106. In one embodiment first electrolyte 104 comprises water, including salt water, seawater, fresh water, brine or brackish water. In another embodiment as illustrated in FIGS. 3-4, a solution containing positive ions is pretreated, e.g., processed through an ion exchange member (not illustrated), to select and or concentrate ions in electrolytes 104, 106. In one embodiment the positive ions comprise sodium ions obtained by selectively subjecting salt water to a membrane ionic separation process 130A obtain a concentrated solution of sodium ions. Similarly, in one embodiment the negative ions comprise chloride ions obtained by selectively subjecting salt water to an ionic membrane separation process 130 B to obtain a concentrated solution of chloride ions.

In various embodiments as illustrated in FIGS. 2-3 the first electrode is configured as an anode comprising iron, tin or magnesium; or a material comprising magnesium, calcium or combinations thereof; or a material comprising one or more mafic minerals, olivine, chrysotile, asbestos, flyash, or combinations thereof. In an embodiments illustrated in FIG. 3 where it is desirable to recover the sacrificial ions of anode 102, e.g., tin or magnesium ions, ions from anode 102 in solution are recycled as the electrolyte surrounding second electrode 134 that functions as a cathode. Thus by switching second electrode 106 with first electrode 102 as illustrated in FIG. 3, the sacrificial material of first electrode is conserved.

Optionally, a gas including CO₂ is dissolved into the first electrolyte. In this optional step the first electrolyte solution can be used to precipitate a carbonate and/or bicarbonate compounds such as calcium carbonate or magnesium carbonate and/or their bicarbonates. The precipitated carbonate compound can be used in any suitable manner, such as e.g., cements and building material as described in United States Patent Applications incorporated herein by reference.

In another optional step, acidified second electrolyte solution 108 is utilized to dissolve a calcium and/or magnesium rich substance, such as a mafic mineral including serpentine or olivine for use as the solution for precipitating carbonates and bicarbonates as described above. In various embodiments, the resulting solution can be used as part or all of the first electrolyte solution. Similarly, in embodiments where hydrochloric acid is produced in second electrolyte 108, the hydrochloric acid can be used in place of, or in addition to, the acidified second electrolyte solution.

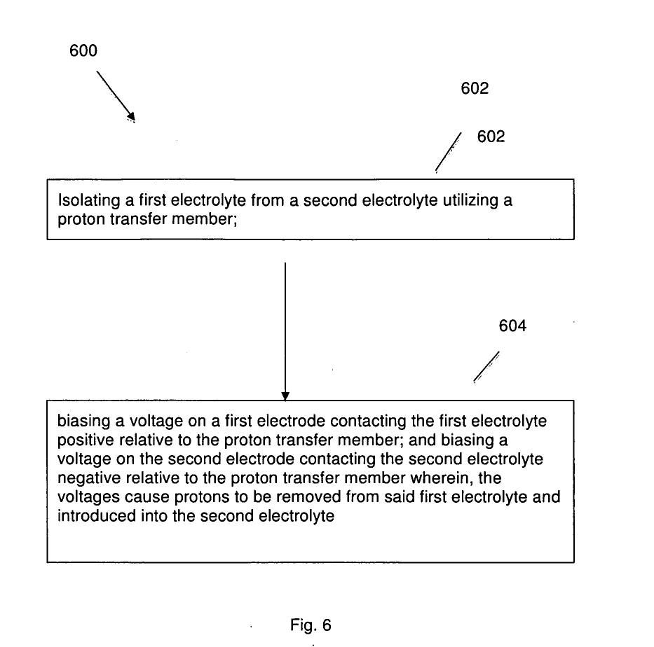

Referring to FIG. 6, the method 600 in another embodiment comprises the step 602 of isolating a first electrolyte 104 from a second electrolyte 108 utilizing a proton transfer member 110; and the step 604 of biasing a voltage on first electrode 102 contacting the first electrolyte positive relative to the proton transfer member, and biasing a voltage on second electrode 106 contacting the second electrolyte 108 negative relative to the proton transfer member. By the method, protons are removed from first electrolyte 104 and introduced into the second electrolyte 108 without generating gas at the electrodes.

In accordance with the methods of FIGS. 5 and 6, by biasing the voltage on the first electrode 102 positively relative to the proton transfer member, and biasing the voltage on the second electrode 106 negative relative to the proton transfer member 110, protons are removed from the first electrolyte by and introduced into the electrolyte on the other side of the proton transfer member, without forming a gas on first electrode 102. Also, as a result of biasing the voltages on the electrodes relative to the proton transfer member, at least a portion of the hydrogen that adsorbs on the surface of the proton transfer member, desorbs as hydrogen ions from the surface of the proton transfer member in contact with the second electrolyte. Consequently, in some embodiments where first electrolyte 104 comprises an aqueous solution, the H⁺ concentration decreases, resulting in an increase in the pH of the first electrolyte, and where the second electrolyte 108 comprises an aqueous solution, the increase in H⁺ ion concentration twill decrease the pH of the second electrolyte.

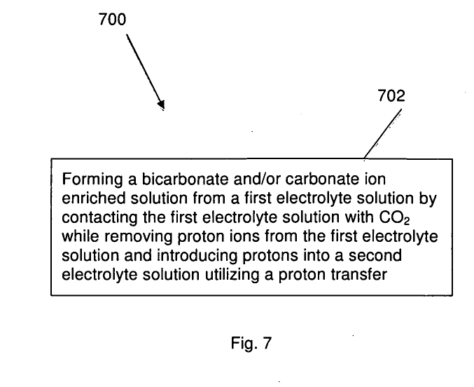

Referring to FIG. 7, the method comprises step 702 of forming bicarbonate and/or carbonate-ion enriched solution from a first electrolyte by contacting the first electrolyte 104 with CO₂ while removing protons from the first electrolyte and introducing protons into a second electrolyte 108 solution utilizing a proton transfer member 110. In accordance with the method, voltage regulators 124A, 124B are operable to establish a current through the electrodes by biasing a voltage on first electrode positive 102 relative to proton transfer member 110, and biasing a voltage on the second electrode 106 negative relative to the proton transfer member. In one application, the CO₂ may be sequestered by pumping the carbonate-enriched solution to an ocean depth at which the temperature and pressure are sufficient to keep the solution stable. In other embodiments, the carbonate may be precipitated e.g., as calcium or magnesium carbonate and disposed of or used commercially as described herein.

Exemplary results achieved in accordance with the present system are summarized in Table 1 below.

TABLE 1
Low Energy Electrochemical Proton Transfer Method and System

| V across | Time | Initial pH at | End pH at | Initial pH at | End pH at |
|---|---|---|---|---|---|
| Electrodes | (min) | Anode | Anode | Cathode | Cathode |
| 0.45 V | 30 | 4.994 | 5.204 | 7.801 | 7.431 |
| 0.30 V in the | | | | | |
| 1^{st}, and 0.15 | | | | | |
| V in the 2^{nd} | | | | | |
| compartment | | | | | |
| 0.50 V | 45 | 4.119 | 4.964 | 5.750 | 5.521 |
| 0.30 V in the | | | | | |
| 1^{st}, and 0.20 | | | | | |
| V in the 2^{nd} | | | | | |
| compartment | | | | | |

In an experimental modeled in accordance with the system of FIG. 1, an electrochemical system comprising two 1-liter compartments 122, 114 separated by a hydrogen transfer membrane 110 was used to transfer H⁺ from seawater 104 charged with CO₂. In the system, the first compartment comprising the first electrolyte was charged with CO₂ until a pH of 4.994 was achieved. A sacrificial anode, e.g., a tin anode was placed into the first compartment, and the tin electrode and the proton transfer member comprising palladium were held under galvanostatic control at 100 nA/cm², which represented a voltage of 0.30V. The second compartment comprising the second electrolyte, e.g., seawater comprising sodium chloride was placed in contact with a tin electrode and SnCl₂ dissolved in the seawater. The palladium proton transfer member and tin electrode in the second compartment where held at 0.15V. The system was run for 30 minutes. As set forth in Table 1, first row, the pH in the first electrolyte increased, and the in pH in the second electrolyte decreased, indicating a transfer of protons from the first electrolyte to the second electrolyte.

In another exemplary system modeled in accordance with the system of FIG. 1, an electrochemical system comprising two 150 mL compartments, one for each electrolyte was provided; a palladium proton transfer member was positioned to separate the electrolytes. In this example a 0.5 molar solution of sodium chloride was placed in each cell. In the first compartment, the first electrolyte was charged with CO₂ to an initial pH of 4.119 and a sacrificial anode, e.g., a tin anode was placed into the first compartment. The tin electrode and the proton transfer member comprising palladium were held under galvanostatic control at 100 nA/cm², which represented a voltage of 0.5V across the electrodes. After running the system for 45 minutes the pH of the first electrolyte changed from 4.119 to 4.964, while the pH of the second electrolyte changed from 5.750 to 5.521 as indicated in Table 1.

Embodiments described above may also produce an acidified stream that can be employed to dissolve calcium and/or magnesium rich minerals. Such an solution can be charged with bicarbonate ions and then made sufficiently basic so as to sequester CO₂ by precipitating carbonate compounds from a solution as described in the United States Patent Applications incorporated by reference herein. Rather than precipitating carbonate minerals to sequester CO₂, in alternative embodiments the carbonate and bicarbonate can be disposed of in a location where it will be stable for extended periods of time. For example, the carbonate/bicarbonate enriched electrolyte solution can be pumped to an ocean depth where the temperature and pressure are sufficient to keep the solution stable over at least the time periods set forth above.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements, which, although not explicitly described or shown herein, embody the principles of the invention, and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

1. An electrochemical method comprising:
biasing a voltage on a first electrode positive relative to a conductive proton transfer member, and
biasing a voltage on a second electrode negative relative to the proton transfer member to establish a current through the first and second electrodes in an electrochemical system wherein
the proton transfer member isolates the first electrolyte from a second electrolyte, the first electrolyte contacts the first electrode and the second electrolyte contacts the second electrode.

2. The method of claim 1, wherein the first electrode comprises an anode and the second electrode comprises a cathode.

3. The method of claim 1, wherein a gas does not form at the electrodes.

4. (canceled)

5. (canceled)

6. The method of claim 1, wherein protons are removed from the first electrolyte.

7. The method of claim 6, wherein at least a portion of the protons are removed through formation of hydrogen gas on the proton transfer member.

8. (canceled)

9. The method of claim 1, wherein the proton transfer member adsorbs hydrogen on a surface contacting the first electrolyte, and desorbs hydrogen from a surface contacting the second electrolyte.

10. (canceled)

11. (canceled)

12. The method of claim 1, wherein the first electrode comprises a sacrificial anode comprising iron or tin.

13. (canceled)

14. (canceled)

15. (canceled)

16. The method of claim 1, wherein the proton transfer member comprises palladium, platinum, palladium alloy, iridium, rhodium, ruthenium, titanium, zirconium, chromium, iron, cobalt, nickel, palladium-silver alloys, palladium-copper alloys or amorphous alloys comprising one or more of these metals.

17. The method of claim 1, further comprising contacting the second electrode with an electrolyte comprising positive ions obtained from an ion-enriched electrolyte from the first electrode.

18. The method of claim 1, further comprising replacing the first electrode with the second electrode, and replacing the second electrode with the first electrode.

19. The method of claim 17, wherein the positive ions comprise Sn^{++.}

20. The method of claim 1, further comprising dissolving carbon dioxide in the first electrolyte.

21. (canceled)

22. The method of claim 1, further comprising precipitating carbonates in the first electrolyte wherein the carbonates comprise calcium carbonate, magnesium carbonates or combinations thereof.

23. (canceled)

24. (canceled)

25. (canceled)

26. (canceled)

27. (canceled)

28. The method of claim 1, wherein the second electrode comprises tin.

29. A method of removing protons from an electrolyte, comprising:
isolating a first electrolyte from a second electrolyte utilizing a proton transfer member; and
biasing a voltage on a first electrode contacting the first electrolyte positive relative to the proton transfer member, and a voltage on the second electrode contacting the second electrolyte negative relative to the proton transfer member wherein
said voltages cause protons to be removed from said first electrolyte and introduced into said second electrolyte.

30. The method of claim 29, wherein a gas does not form at the electrodes.

31. (canceled)

32. (canceled)

33. (canceled)

34. The method of claim 29, wherein protons are removed from the first electrolyte.

35. (canceled)

36. (canceled)

37. The method of claim 29, wherein the first electrode comprises a sacrificial electrode comprises iron, tin or magnesium.

38. (canceled)

39. An electrochemical system comprising:
a first electrode contacting a first electrolyte;
a second electrode contacting a second electrolyte;
a proton transfer member isolating the first electrolyte from the second electrolyte; and
a voltage regulator operable for biasing a voltage on the first electrode positive relative to the proton transfer member, and for biasing a voltage on the second electrode negative relative to the proton transfer member.

40. The system of claim 39, wherein the voltage regulator is set to a voltage such that a gas does not form at the electrodes.

41. (canceled)

42. (canceled)

43. (canceled)

44. (canceled)

45. (canceled)

46. The system of claim 39, wherein the proton transfer member comprises palladium, platinum, iridium, rhodium, ruthenium, titanium zirconium, chromium, iron, cobalt, nickel, palladium-silver alloys, or palladium-copper alloys.

47. (canceled)

48. The system of claim 39, further comprising a conduit for introducing positive ions into the first electrolyte and negative ions into the second electrolyte.

49. The system of claim 39, wherein the positive ions comprise sodium ions and the negative ions comprise chloride ions.

50. (canceled)

51. The system of claim 39, wherein the positive ions comprise Sn^{++.}

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. (canceled)

67. A method comprising: forming a carbonate ion enriched solution from a first electrolyte solution by contacting the first electrolyte solution with CO₂ while transferring hydrogen ions from the first electrolyte solution to a second electrolyte solution utilizing a proton transfer member.

68. The method of claim 67, further comprising precipitating a carbonate mineral from the carbonate enriched solution.

69. (canceled)

70. The method of claim 67, further comprising dissolving a calcium and/or magnesium bearing substance with the second electrolyte solution.

71. (canceled)

72. The method of claim 70, further comprising: sequestering CO₂ by pumping the carbonate enriched solution to an ocean depth at which the temperature and pressure are sufficient to keep the solution stable.

73. (canceled)

74. (canceled)

75. (canceled)

76. (canceled)

77. (canceled)

78. (canceled)
